(19) United States
(12) Patent Application Publication
(10) Pub. No.: US 2020/0311411 A1
(43) Pub. Date: Oct. 1, 2020

(54) METHOD FOR TEXT MATCHING AND CORRECTION

(71) Applicant: Konica Minolta Laboratory U.S.A., Inc., San Mateo, CA (US)

(72) Inventors: Shubham AGARWAL, Belmont, CA (US); Yongmian ZHANG, Union City, CA (US)

(21) Appl. No.: 16/368,312

(22) Filed: Mar. 28, 2019

(51) Int. Cl. G06K 9/00; G06F 17/27

(52) U.S. Cl. CPC G06K 9/00469; G06K 2209/01; G06F 17/276

(57) ABSTRACT

A text recognition method and system involves computing a text matching score between an input text and an output candidate text. The text matching score is computed by evaluating respective N-grams of the input text and the output candidate text. The N-grams are compared in pairs for visual similarity by determining N-gram pair scores, which are used to compute the text matching score. The N-gram pair scores are determined using a set of probabilities of confusion between characters contained in the N-grams. The described approach can address inconsistent results that arise from conventional text similarity quantifiers.

### FIELD

This disclosure relates generally to image processing and, more particularly, to correct recognize text in an image.

### BACKGROUND

Computerized text recognition methods are used in many situations, such as when converting a scanned image into text for editing and archiving. Such systems often suffer from various scanning artifacts, varying font styles and text sizes. A major difficulty in developing a generalized solution lies in interpreting text content with high accuracy. The recognized text may contain an error, such as missing or extra characters and/or misidentification of characters (confusing a character for another character) when they are structurally similar, sometimes referred to as visually similar (e.g., “e” identified as “c”). Various error correction and dictionary matching methods have been developed to tackle this issue. The dictionary may propose various candidate texts for the erroneous text. The candidates are ranked according to a similarity quantifier, such as Levenshtein distance and cosine similarity. Both of these quantifiers are well known. Briefly, Levenshtein distance refers to a count of single-character edits (insertions, deletions or substitutions) required to make one text string identical to the other. A lower Levenshtein distance indicates greater similarity. Cosine similarity is a vector-based approach that applies the Euclidean cosine rule to quantify similarity. A greater value for cosine similarity indicates greater similarity.

TABLE I shows two candidate text strings provided for the input text string “bcars”. Candidate “bars” has a fewer characters than input “bcars”. Candidate “bears” has the same number of characters as input “bcars,” with only one character (“e”) being substituted for a similar looking character (“c”) at the same location. Letters “e” and “c” are structurally similar since both are short and have a curved element with an opening on its right side. Thus, candidate “bears” clearly has higher structural similarity to “bcars,” but Levenshtein distance indicates that both candidates “bears” and “bars” have the same level of similarity to input “bcars,” and cosine similarity ranks candidate “bears” lower in similarity.

TABLE I

| Input | Candidate | Structural | Levenshtein | Cosine |
|---|---|---|---|---|
| String | String | Similarity | Distance | Similarity |
| bcars | bars | lower | 1 | 89% |
| | bears | higher | 1 | 80% |

In TABLE II, the input text string is “fisten”. Candidate “listen” clearly has higher structural similarity to input “fisten” due to there being only one character (“l”) being substituted for a similar looking character (“f”) at the same location. Characters “l” and “f” are structurally similar since both have a single element that is tall and vertical. However, cosine similarity indicates that both candidates “listen” and “silent” have the same level of similarity to input “fisten”.

TABLE II

| Input | Candidate | Structural | Levenshtein | Cosine |
|---|---|---|---|---|
| String | String | Similarity | Distance | Similarity |
| fisten | silent | lower | 4 | 83% |
| | listen | higher | 1 | 83% |

Accordingly, there is a need for a text recognition method and system that can address the inconsistencies of conventional similarity quantifiers.

### SUMMARY

Briefly and in general terms, the present invention is directed to a text recognition method and system.

In aspects of the invention, a method comprises obtaining a plurality of output candidate texts for an input text, the input text defined by a plurality of N-grams, each output candidate text defined by a plurality of N-grams. The method comprises computing a text matching score for each one of the output candidate texts. The computing for each output candidate text comprises using the N-grams of the input text, the N-grams of the output candidate text, and a set of probabilities of confusion between characters to determine an N-gram score for each one of a plurality of N-gram pairs, each N-gram pair comprising a respective one of the N-grams of the input text and a respective one of the N-grams of the output candidate text. The computing for each output candidate text comprises using the N-gram score of one or more of the N-gram pairs to compute the text matching score of the output candidate text. The method comprises selecting one of the output candidate texts to be an output text for the input text, the selecting performed according to the text matching score of the output text.

In aspects of the invention, a system comprises a processor and a memory, the memory in communication with the processor. The memory stores instructions. The processor is configured to perform a text recognition process according to the stored instructions. The text recognition process comprises obtaining a plurality of output candidate texts for an input text, the input text defined by a plurality of N-grams, each output candidate text defined by a plurality of N-grams. The text recognition process comprises computing a text matching score for each one of the output candidate texts. The computing for each output candidate text comprises using the N-grams of the input text, the N-grams of the output candidate text, and a set of probabilities of confusion between characters to determine an N-gram score for each one of a plurality of N-gram pairs, each N-gram pair comprising a respective one of the N-grams of the input text and a respective one of the N-grams of the output candidate text. The computing for each output candidate text comprises using the N-gram score of one or more of the N-gram pairs to compute the text matching score of the output candidate text. The text recognition process comprises selecting one of the output candidate texts to be an output text for the input text, the selecting performed according to the text matching score of the output text.

The features and advantages of the invention will be more readily understood from the following detailed description which should be read in conjunction with the accompanying drawings.

### BRIEF DESCRIPTION OF THE DRAWINGS

FIG. 1 is a flow diagram illustrating an example text recognition method.

FIG. 2 is a tabular example of a set of probabilities of confusion between characters.

FIG. 3 is another tabular example of a set of probabilities of confusion between characters.

FIGS. 4A to 4C are diagrams showing example N-gram score matrices used to compute a text matching score for each of three output candidate texts for first input text “fisten”.

FIG. 5 is a flow diagram illustrating an example rule for determining an N-gram score.

FIGS. 6A to 6C are diagrams showing example N-gram score matrices used to compute a text matching score for each of three output candidate texts for second input text “bcars”.

FIG. 7 is a diagram showing an example N-gram score matrix used to compute a text matching score for output candidate text “Planes & trains” for input text “Plans & frains”.

FIG. 8 is a schematic diagram showing an example system for text recognition, the system comprising an apparatus and an external device connected to the apparatus via a network.

### DETAILED DESCRIPTION

The terms “text,” “string,” and “text string” are used interchangeably and refer to a group of characters. A group of characters may consist exclusively of a single word, or may comprise groups of words with space characters and punctuation characters. In a group of characters, the characters may be those of any written alphabet (e.g., English, Greek, Cyrillic, and Hebrew), logographic and syllabic characters (e.g., characters used in Japan and China), script characters (e.g., used in Hindi and Arabic), mathematical characters, and/or for other character types.

The term “N-gram” refers to a group of characters that consists of a total of N characters. The term N-gram encompasses a 3-gram (group of characters that consists of a total of N=3 characters) and a 4-gram (group of characters that consists of a total of N=4 characters). The term N-gram encompasses any value for N, where N may be greater than 2, greater than 3, greater than 4, or greater than 5.

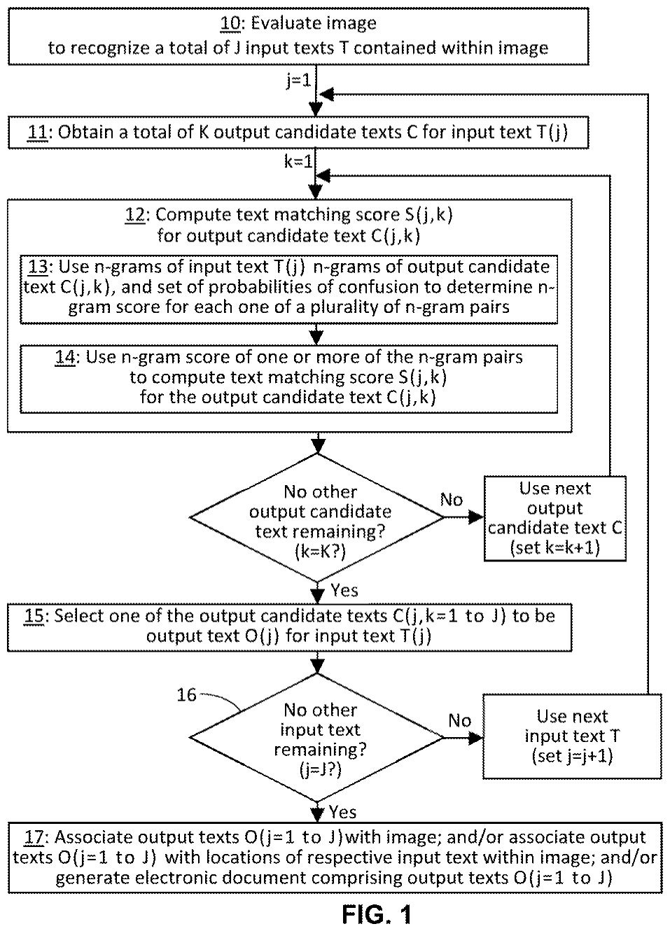

Referring now in more detail to the drawings for purposes of illustrating non-limiting examples, wherein like reference numerals designate corresponding or like elements among the several views, there is shown in FIG. 1 an example text recognition method. An image is obtained, such as by scanning a document. The image is an electronic image. The electronic image may have a tiff, jpg, bmp, pdf or other data format.

At block 10, the image is evaluated by a computer to recognize one or more input texts. The computer may use a character recognition algorithm to recognize one or more input texts. For example, the document may contain original word “listen” and “bears”, and the computer recognizes these original words to be “fisten” and “bcars”, respectively. The recognized words are examples of input text. In this example, there are J=2 input texts that are recognized by the computer, and each input text consists of a single word. Each recognized word is represented as T(j), where j varies from 1 to J. Input text T(1)=fisten and input text T(2)=bcars. The method proceeds with input text T(1)=fisten.

At block 11, output candidate texts are obtained for the current input text, namely T(1)=fisten. The computer may reference a dictionary or other listing of words to obtain the output candidate texts. For example, the dictionary may have a total of K words as proposed corrections to “fisten”. Each proposed correction may be referred to as a dictionary word. Each proposed correction is an example of an output candidate text. As shown for example in TABLE III, the output candidate texts may be “silent”, “listen”, and “tinsel”. Each output candidate text for T(1)=fisten may be represented as C(1,k), with k varying from 1 to K. In this example, there are K=3 output candidates texts for input text T(1)=fisten. The output candidate texts are C(1,1)=silent, C(1,2)=listen, and C(1,3)=tinsel.

TABLE III

| Input | Candidate | Levenshtein | Cosine | Text |
|---|---|---|---|---|
| Text | Text | Distance | Similarity | Matching Score S |
| fisten | silent | 4 | 83% | 0.177 |
| | listen | 1 | 83% | 0.672 |
| | tinsel | 4 | 83% | 0.000 |

At block 12, a text matching score is computed for each output candidate text C(1,1)=silent, C(1,2)=listen, and C(1,3)=tinsel. Note that j=1 at this point in the method. At block 13, for example, each computation comprises using N-grams of the input text, namely T(1)=fisten, N-grams of the current output candidate text (silent, listen or tinsel), and a set of probabilities of confusion between characters. These elements are used to determine an N-gram score for each one of a plurality of N-gram pairs. Each N-gram pair comprises a respective one of the N-grams of the input text (fisten) and a respective one of the N-grams of the output candidate text (silent, listen or tinsel).

The N-grams of any text is a set of N sequential characters that correspond to the characters text in terms of position and content. That is, an N-gram contains characters having the same character value and character position as the characters in the text. The first N-gram is the set of N sequential characters at the beginning of the text. The second N-gram is the set of N sequential characters after the first character of the text, the third N-gram is the set of N sequential characters after the second character of the text, and so on. The text is defined by its N-grams in the sense that the text can be reconstructed by superimposing its N-grams.

The N-grams have the same total number of characters. The total number of characters N in the N-gram may be 3, greater than 3, greater than 4, or greater than 5. An N-gram with N=3 characters is referred to as a trigram. For example, the trigrams for text “abcdefg” would be abc, bcd, cde, def, and efg. Text “abcdefg” is defined by its trigrams in the sense that “abcdefg” can be reconstructed by superimposing the trigrams.

For example, input text T(1)=fisten is defined by trigrams fis, ist, ste, and ten. Candidate text C(1,1)=silent is defined by trigrams sil, ile, len, and ent. These N-grams result in input-candidate N-gram pairs. For example, fis (the starting trigram of the input text) can be paired with any of sil, ile, len, and ent (the trigrams of the output candidate text “silent”). Also, ist (the next trigram of the input text) can be paired with any of sil, ile, len, and ent (the trigrams of the output candidate text “silent”). These N-grams together with a set of probabilities of confusion between characters are used to determine an N-gram score for each N-gram pair.

The set of probabilities of confusion between characters will now be described. The method of recognizing input texts has inherent uncertainty in that each character (e.g., a, b, c) has a probability of being accidentally recognized as another character. For example, the probability that letter a in original text (i.e., original character “a”) is recognized as the letters a, b, and c may be 0.866, 0.00, and 0.067, respectively. Thus, the method assumes that original character “a” has a 86.6% chance of being correctly recognized as character “a”, has a 0% chance of being misidentified as character “b”, and has a 6.7% chance of being misidentified as character “c”. An example set of probabilities of confusion includes probabilities 0.866, 0.00, and 0.067.

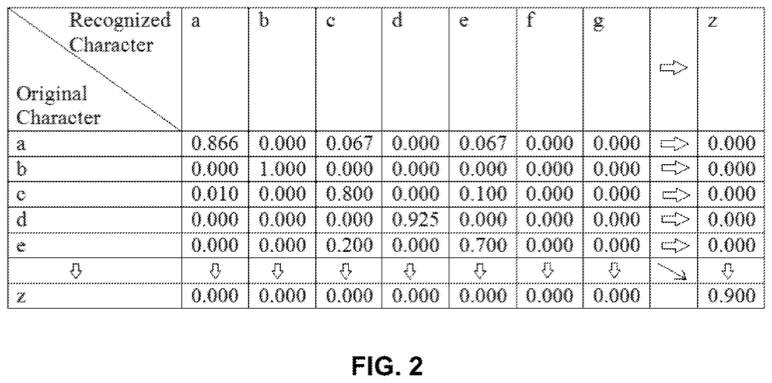

FIG. 2 shows another example set of probabilities of confusion for characters of the English alphabet. The set of probabilities is shown in table form, with columns corresponding to recognized characters. The table is an example of a confusion matrix. The table omits recognized characters “h” through “y” and original characters “f” through “x” for simplicity, and it is to be understood that the table may contain additional cells for upper case letters.

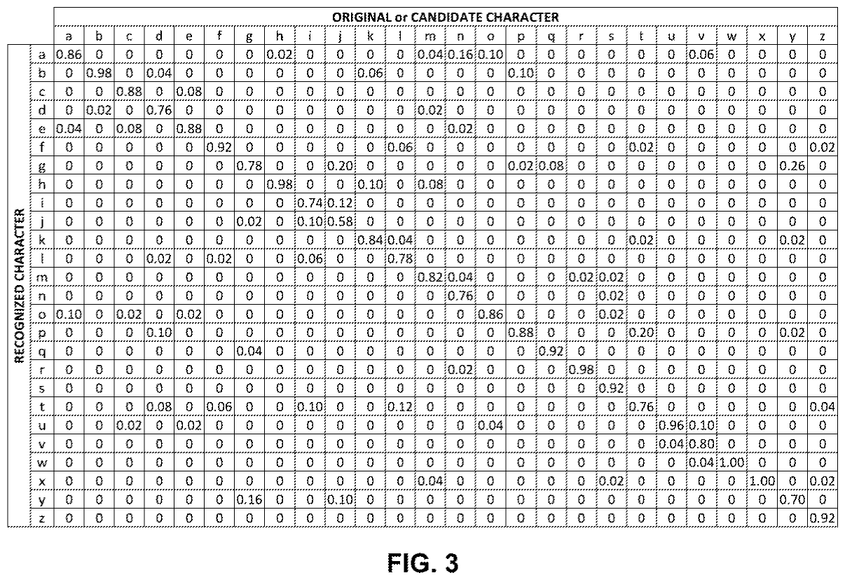

FIG. 3 shows different set of probabilities of confusion for characters of the English alphabet. The table of FIG. 3 is another example of a confusion matrix. Unlike the previous example, the columns correspond to original characters. Thus, the sum of probabilities in each column is 1.0 or 100%.

In general, the set of probabilities depends on the type of text that is contained in image. For Hebrew text, the set of probabilities would be for Hebrew characters. It is contemplated that the set of probabilities may be for characters of other alphabets (e.g., Greek, Cyrillic, and Hebrew), for logographic and syllabic characters (e.g., characters used in Japan and China), for script characters (e.g., Hindi and Arabic), for mathematical characters, and/or for other character types.

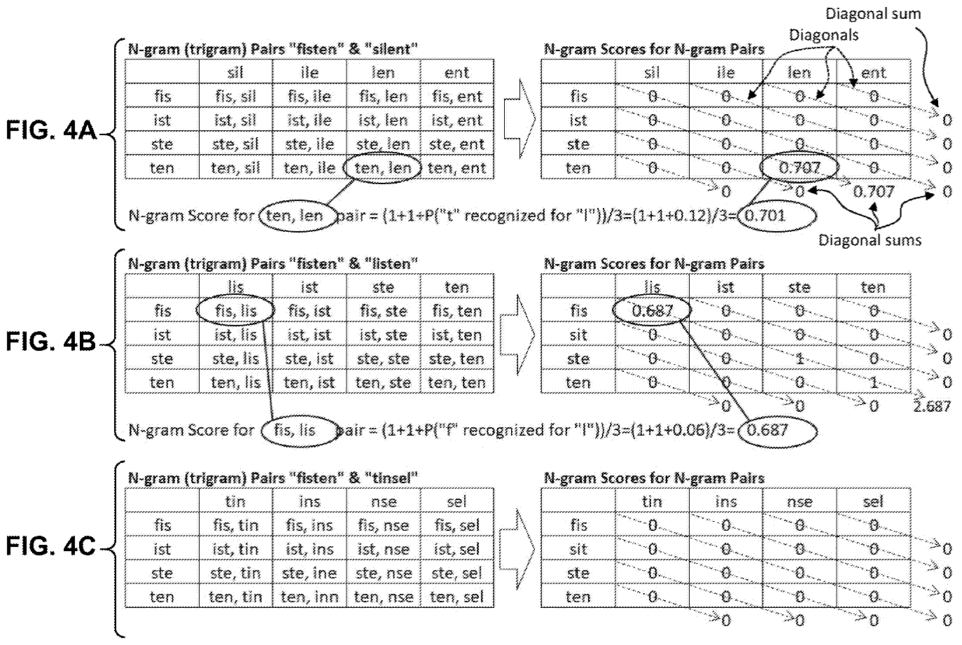

FIG. 4A shows N-gram pairs for input text T(1)=fisten and output candidate text C(1,1)=silent and the N-gram scores computed for those N-gram pairs. For each N-gram pair, the N-gram score is computed by applying a rule. For example, the rule may comprise setting the N-gram score to a probability-based value if the N-gram of the input text and the N-gram of the output candidate text of the N-gram pair differ in content by no more than one character position. A trigram has three character positions, so this rule has the effect of identifying visual similarity in the form of two character positions that are the same in content.

In FIG. 4A, all but one of the N-gram pairs differ in content by more than one character position. For instance, the N-gram pair at the top left corner is “fis, sil”. This N-gram pair has two character contents (namely “i” and “s”) that are the same in both trigrams, but character “s” is not located at the same in position in both trigrams. Only the middle character position has the same content (namely “i”) in both trigrams, which indicates that the trigrams are not visually similar to a sufficient degree. Thus, the N-gram score is not set to a probability-based value. For example, the rule discussed may further comprise setting the N-gram score to a minimal value V min if the N-gram pair differs in content by more than one character position.

In FIG. 4A, only N-gram pair “ten, len” differs in content by no more than one character position. In this N-gram pair, only the starting character differs in content (t versus l). The two remaining characters positions are the same in content. That is, the characters “e” and “n” occupy the same position in both trigrams, which indicates that the trigrams are visually similar. Thus, according to the rule discussed above, the N-gram score is set to a probability-based value. The probability-based value is based on a probability of confusion between a differentiating character (character “t”) of the N-gram (“ten”) of the input text (“fisten”) and a differentiating character (character “l”) of the N-gram (“len”) of the output candidate text (“silent”). For example, the probability-based value (Vp) may be computed according to Eqn. (equation) 1A when trigrams (i.e., a 3-gram with 3 characters) are used.

N-gram score=Vp=(1+1+P(“t” recognized for “l”))/3 Eqn. 1A

In Eqn. 1A, Vp is the normalized sum of three values that correspond to the three character positions of the trigram pair. The sum is normalized according to the total character count (e.g., 3) in each N-gram. A full value (e.g., 1) is used for each character position that is the same in content. A partial value is used for each character position that that is not the same in content. The partial value is the probability P that the recognized character (character “t”) is actually intended to be the candidate character (character “l”). The probability is taken from the set of probabilities of confusion for characters. For example, FIG. 3 shows that that there is a 0.12 or 12% probability that an original character “l” is recognized as character “t”. The same probability is applied for candidate character “t” in trigram “ten”. That is, there is a 0.12 or 12% probability that character “t” was incorrectly recognized for character “l” in the image. Thus, the the N-gram score for N-gram pair “ten, len” is 0.707, as shown in FIG. 4A.

In another example, the probability-based value (Vp) may be computed according to Eqn. 1B when 4-grams (with 4 characters) are used.

N-gram score=Vp=(1+1+1+P)/4 Eqn. 1B

In Eqn 1B, Vp is the normalized sum of four values that correspond to the four character positions of the 4-gram. The sum is normalized by the total number of characters (e.g., 4) in each 4-gram. A full value (e.g., 1) is used for each character position that is the same in content. There are three full values in Eqn. 1B due to the rule that the N-gram of the input text and the N-gram of the output candidate text of the N-gram pair differ in content by no more than one character position. This means that three character positions will be the same in content. The partial value in Eqn. 1B is the probability P, which is determined in the same way as in Eqn. 1A.

FIG. 4B shows N-gram pairs for input text T(1)=fisten and output candidate text C(1,2)=listen and the N-gram scores computed for those N-gram pairs. For each N-gram pair, the N-gram score is computed by applying the same rule that was applied for C(1,1). Continuing with above example, the rule comprises setting the N-gram score to probability-based value Vp if the N-gram of the input text and the N-gram of the output candidate text of the N-gram pair differ in content by no more than one character position. In addition, the rule comprises setting the N-gram score to minimal value V min if the N-gram pair differs in content by more than one character position. In addition, the rule comprises setting the N-gram score to maximum value V max if the N-gram of the input text and the N-gram of the output candidate text of the N-gram pair have all character positions that are the same in content. For example, maximum value V max may be computed according to Eqn. 2A when trigrams (i.e., a 3-gram with 3 characters) are used. In this example V max=1.

N-gram score=V max=(1+1+1)/3=1 Eqn. 2A

In Eqn. 2A, V max is the normalized sum of three values that correspond to the three character positions of the trigram. A full value (e.g., 1) is used for each character position that is the same in content. There are three full values due to there being three character positions that are the same in content.

In another example, the maximum value (V max) may be computed according to Eqn. 2B when 4-grams (with 4 characters) are used.

N-gram score=V max=(1+1+1+1)/4=1 Eqn. 2B

In Eqn. 2B, V max is the normalized sum of four values that correspond to the four character positions of the 4-gram. A full value (e.g., 1) is used for each character position that is the same in content. There are four full values because there are four character positions that are the same in content.

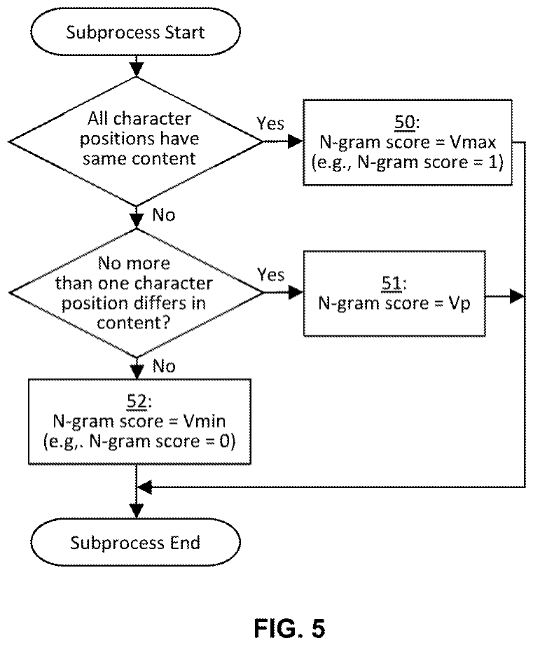

FIG. 5 shows an example rule that may be applied to compute the N-gram score for each N-gram pair. The following relationship in Eqn. 3 is always true for V min, Vp, and V max. V min is always less than Vp, and Vp is always less than V max.

V min<Vp<V max Eqn. 3

In FIG. 4B, there are two N-gram pairs in which all character positions are the same in content for the N-gram of the input text and the N-gram of the output candidate text. Thus, according to block 50 (FIG. 5), the N-gram scores for these N-gram pairs are set to V max (e.g., N-gram score=1). In FIG. 4B, there is a single N-gram pair (“fis, lis”) in which the N-gram of the input text and the N-gram of the output candidate text of the N-gram pair differ in content by no more than one character position. Thus, according to block 51 (FIG. 5), the N-gram score for N-gram pair “fis, lis” is set to Vp. Since the N-grams are trigrams in this example, the N-gram score may be determined using Eqn. 1A, which results in N-gram score=Vp=0.687. All remaining N-gram pairs differ in content by more than one character position. Thus, according to block 52 (FIG. 5), the N-gram score for all remaining N-gram pairs is set to V min (e.g., N-gram score=0).

FIG. 4C shows N-gram pairs for input text T(1)=fisten and output candidate text C(1,3)=tinsel and the N-gram scores computed for those N-gram pairs. There are no N-gram pairs in which the input text and the N-gram of the output candidate text of the N-gram pair have all character positions that are the same in content. There is no N-gram pair for which the N-gram of the input text and the N-gram of the output candidate text of the N-gram pair differ in content by no more than one character position. Thus, according to block 52 (FIG. 5), the N-gram score for all N-gram pairs are set to V min (e.g., N-gram score=0).

Referring again to FIG. 1, text matching score S(j, k) is computed at block 14 for the current output candidate text C(j, k) by using the N-gram score of one or more of the N-gram pairs for C(j, k) and input text T(j). For example, text matching score S(j, k) may be determined using a matrix of N-gram scores.

FIG. 4A shows an example matrix of N-gram scores. The matrix is illustrated as a 2-dimentional table. Each cell of the matrix is arranged along a first matrix dimension and a second matrix dimension. The first matrix dimension corresponds to the N-grams (fis, ist, ste, and ten) of the input text (“fisten”) arranged in sequential order. The second matrix dimension corresponds to the N-grams (sil, ile, len, ent) of the candidate text (“silent”) arranged in sequential order. Each cell of the matrix contains the N-gram score of an N-gram pair defined by a matrix intersection of a respective N-gram of the first matrix dimension and a respective N-gram of the second matrix dimension. For instance, N-gram score=0.707 for N-gram pair “ten, len” is contained in a matrix cell defined by a matrix intersection of “ten” and “len”.

The text matching score is determined from a sum that is greatest among a plurality of sums, where each sum is a sum of N-gram scores taken across a respective diagonal along one or more cells of a matrix. As will become apparent below, taking a sum across a diagonal (referred to as a diagonal sum) results in emphasis being placed on sequentially arranged N-grams of the output candidate text that are visually similar to N-grams of the input text.

In FIG. 4A, the set of sums is {0, 0, 0.707, 0, 0, 0, 0}. The greatest sum is referred to as maximal sum Max Sum. In FIG. 4A, Max Sum=0.707. Thus, text matching score S(1,1) is determined from 0.707. For example, the text matching score may be determined by normalizing Max Sum according to a total count (A) of the N-grams of the input text or a total count (B) of the N-grams of the output candidate text. The values of A and B depend on the total number of characters in the input text and output candidate text, respectively. Counts A and B will be unequal if the total number of characters in the input text and output candidate text are unequal. Thus, in a further example, the text matching score may be determined according to Eqn. 4 by normalizing Max Sum according to the greater of A and B.

Text Matching Score S=Max Sum/max(A, B) Eqn. 4

where Max Sum=greatest sum among the plurality of diagonal sums,
A=total number of characters in the input text,
B=total number of characters in the output candidate text, and
max(A, B)=greater of A and B

In FIG. 4A, Max Sum=0.707, A=4, and B=4. In FIG. 1, j=1 and k=1, and text matching score S(1,1) is computed at block 14. According to Eqn. 4 and a probability value taken from FIG. 3, text matching score S(1,1)=0.707/4=0.177.

In FIG. 4B, Max Sum=2.687, A=4, and B=4. In FIG. 1, j=1 and k=2, and text matching score S(1,2) is computed at block 14. According to Eqn. 4 and a probability value taken from FIG. 3, text matching score S(1,2)=2.687/4=0.672. The relatively high score of 0.672 is a result of summing sequentially arranged N-grams (list, ste and ten) of the output candidate text that are visually similar or identical to the N-grams of the input text.

In FIG. 4C, Max Sum=0, A=4, and B=4. In FIG. 1, j=1 and k=3, and text matching score S(1,3) is computed at block 14. According to Eqn. 4, text matching score S(1,3)=0/4=0.

At FIG. 1 block 15, one of the output candidate texts is selected to be an output text for the input text. The selection is performed according to the text matching score of the output candidate text what was selected (i.e., according to the text matching score of the output text). For the Example of TABLE III, output candidate text “listen” is selected to be the output text since its text matching score of 0.672 is greater than the text matching scores for the output candidate texts. Thus, O(1)=listen at block 15. The word “listen” is an example of a corrected output for the word “fisten” that was recognized by the system in block 10.

As previously mentioned, taking a sum across a matrix diagonal results in emphasis being placed on sequentially arranged N-grams of the output candidate text that are visually similar to N-grams of the input text. Output candidate text “listen” is selected because it has three sequentially arranged N-grams (lis, ste and ten) that are either visually similar or identical to the N-grams of the input text.

Next at block 16, the method determines whether there is any other input text remaining to be evaluated. Continuing from the example above, input text “bcars” was also recognized at block 10. Thus, j is incremented (set j=j+1) so that the next input text (“bcars”) is evaluated according to blocks 11 through 14.

At block 11 with j=2, output candidate texts are obtained for the current input text, namely T(2)=bcars. As shown for example in TABLE IV, the output candidate texts may be “silent”, “listen”, and “tinsel”. In this example, there are K=3 output candidates texts for input text T(2)=bcars. The output candidate texts are C(2,1)=bars, C(2,2)=bears, and C(2,3)=boars.

TABLE IV

| Input | Candidate | Levenshtein | Cosine | Text |
|---|---|---|---|---|
| Text | Text | Distance | Similarity | Matching Score S |
| bcars | bars | 1 | 89% | 0.556 |
| | bears | 1 | 80% | 0.564 |
| | boars | 1 | 80% | 0.556 |

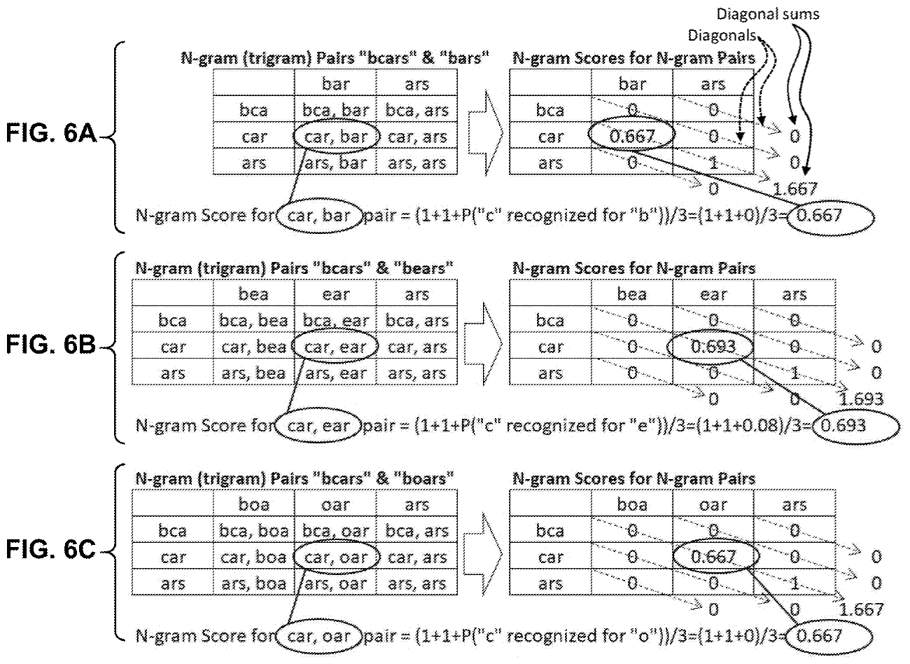

FIGS. 6A to 6C show N-gram pairs for input text T(2)=bcars and three output candidate texts from TABLE IV.

In FIG. 6A, Max Sum=1.667, A=2, and B=3. In FIG. 1, j=2 and k=1, and text matching score S(2,1) is computed at block 14. According to Eqn. 4 and a probability value taken from FIG. 3, text matching score S(2,1)=1.667/3=0.556.

In FIG. 6B, Max Sum=1.693, A=3, and B=3. In FIG. 1, j=2 and k=2, and text matching score S(2,2) is computed at block 14. According to Eqn. 4 and a probability value taken from FIG. 3, text matching score S(2,2)=1.693/3=0.564.

In FIG. 6C, Max Sum=1.667, A=3, and B=3. In FIG. 1, j=2 and k=3, and text matching score S(2,3) is computed at block 14. According to Eqn. 4 and a probability value taken from FIG. 3, text matching score S(2,3)=1.667/3=0.556.

At FIG. 1 block 15, one of the output candidate texts is selected to be an output text for input text “bears”. For the Example of TABLE IV, output candidate text “bears” is selected to be the output text since its text matching score of 0.564 is greater than the text matching scores for the output candidate texts. Thus, O(2)=bears at block 15. As previously mentioned, the diagonal sums (sum across a matrix diagonal) result in emphasis being placed on sequentially arranged N-grams of the output candidate text that are visually similar to N-grams of the input text. The selection of output candidate text “bears” arises from it having two sequentially arranged N-grams (ear and ars) that are either identical or visually similar to the N-grams of the input text, coupled with the relatively high probability of 8% of character “c” possibly being “e”. The 8% probability reflects the fact that candidate character “e” has a relatively high degree of visual similarity to input character “c” as compared to candidate character “o”.

Next, at block 16, the method again determines whether there is any other input text remaining to be evaluated. Continuing from the example above, there are J=2 input texts recognized at block 10. Since j=J, there are no other input texts remaining and the method proceeds to block 17.

At block 17, the method associates the selected output texts “listen” and “bears” with the image. This can facilitate a search operation in which a person wants to find all images that contain the word “listen” or “bears”. Such a search would return the present image if it is associated with output texts “listen” and “bears”. Associating the selected output texts “listen” and “bears” with the image may include encoding the image with the output texts.

Additionally or alternatively, the method associates output texts “listen” and “bears” with locations of their respective input texts within the image. This can facilitate a search operation in which a person wants find to the location of words “listen” or “bears” within the image. Such a search may indicate, for example, that the word “listen” is located at the middle of the image. Associating output texts “listen” and “bears” with respective locations within the image may include encoding the image with the output texts together and their locations.

Additionally or alternatively, the method generates an electronic document that comprises output texts “listen” and “bears”. For example, the electronic document may be a txt file, MS-Word™ file, PDF file, or other format. The format may be an editable format to allow a user to make additions or edits to the electronic document.

From the foregoing, it will be appreciated that the described method incorporates error statistics (probabilities of confusion between characters) unique to or assigned to a recognition system, thereby allowing for a determination of a text matching score that is more aligned to system behavior (e.g., lesser or greater tendency of the system to mistakenly recognize a certain character compared to another system). In addition, the error statistics allow for visual similarity between characters (e.g., characters “c” and “e”) to be factored into the text matching score. Normalization of the text matching score facilitates ranking among multiple output candidate texts that may differ in total number of characters. Furthermore, scoring individual N-gram pairs and using diagonal sums allow for visual similarity at a group level (e.g., a group of N characters) to be factored into the text matching score.

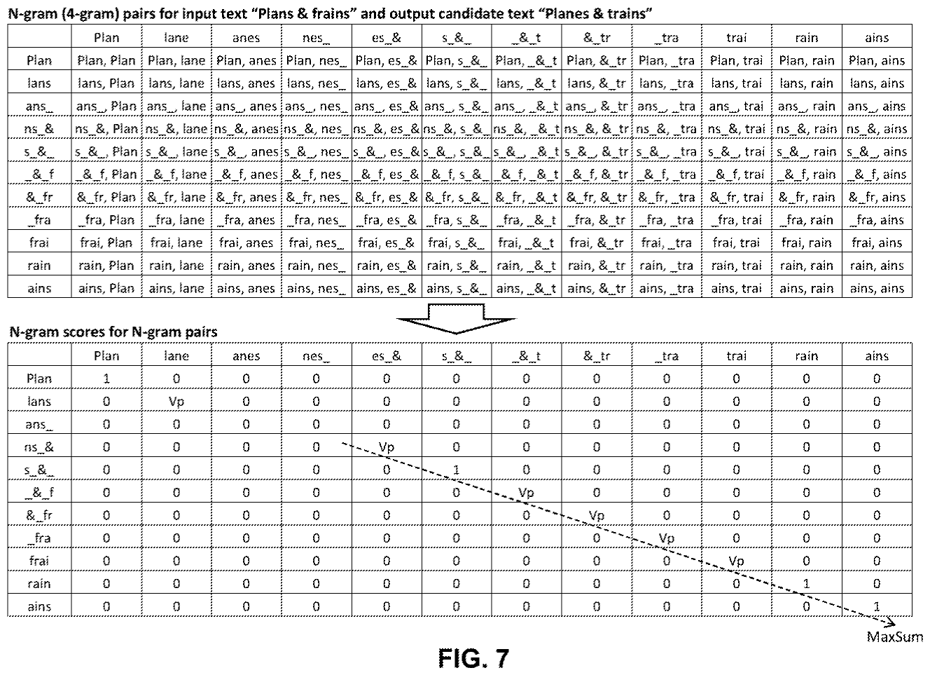

FIG. 7 shows an example for input text “Plans & frains” and output candidate text “Planes & trains”. Both the input text and the output candidate text comprise words, space characters (illustrated with an underscore), and an ampersand character (“&”). The N-grams are 4-grams, each with four total character positions. Some of the 4-grams contain the space character and/or the ampersand character. The N-gram scores are determined according to the rule of FIG. 5, with V max set to 1 and V min set to 0. Vp may be computed using a set of probabilities of confusion between characters, which set includes the probabilities for the ampersand character. Diagonal sums would be computed from the N-gram scores, though only the greatest diagonal sum (Max Sum) is labeled in FIG. 7. Max Sum may be used to compute a text matching score according to Eqn. 4.

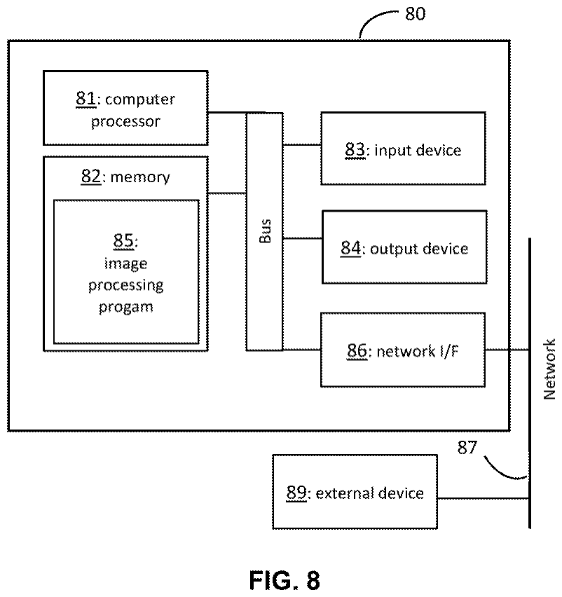

FIG. 8 shows example recognition system that comprises apparatus 80 configured to perform the methods and processes described herein. Apparatus 80 can be a server, computer workstation, personal computer, laptop computer, tablet, smartphone, facsimile machine, printing machine, multi-functional peripheral (MFP) device that has the functions of a printer and scanner combined, or other type of machine that includes one or more computer processors and memory.

Apparatus 80 includes one or more computer processors 81 (CPUs), one or more computer memory devices 82, one or more input devices 83, and one or more output devices 84. The one or more computer processors 81 are collectively referred to as processor 81. Processor 81 is configured to execute instructions. Processor 81 may include integrated circuits that execute the instructions. The instructions may embody one or more software modules for performing the processes described herein. The one of more software modules are collectively referred to as text recognition program 85.

The one or more computer memory devices 82 are collectively referred to as memory 82. Memory 82 includes any one or a combination of random-access memory (RAM) modules, read-only memory (ROM) modules, and other electronic devices. Memory 82 may include a mass storage device such as optical drives, magnetic drives, solid-state flash drives, and other data storage devices. Memory 82 includes a non-transitory computer readable medium that stores text recognition program 85. Memory 82 may store a set of probabilities of confusion between characters (e.g., probabilities of FIG. 2 or FIG. 3).

The one or more input devices 83 are collectively referred to as input device 83. Input device 83 may include an optical scanner having a camera and light source and which is configured to scan a document page to generate an input image that is subsequently evaluated at block 10 (FIG. 1). Input device 83 can allow a person (user) to enter data and interact with apparatus 80. Input device 83 may include any one or more of a keyboard with buttons, touch-sensitive screen, mouse, electronic pen, and other types of devices that can allow the user to initiate execution of text recognition program 85 by computer processor 81, and/or allow the user to identify a set of probabilities of confusion between characters, and/or allow the user to perform a search operation discussed above.

The one or more output devices 84 are collectively referred to as output device 84. Output device 84 may include a liquid crystal display, projector, or other type of visual display device. Output device 84 may include a printer capable of printing the input image. Output device 84 may be used to display or print the output texts that were selected at block 15 (FIG. 1).

Apparatus 80 includes network interface (I/F) 86 configured to allow apparatus 80 to communicate with other machines through network 87, such as a local area network (LAN), a wide area network (WAN), the Internet, and telephone communication carriers. Network I/F 86 may include circuitry enabling analog or digital communication to device 89 through network 87.

External device 89 may store an input image, and network I/F 86 may be configured to receive the input from external device 89 to allow processor 81 to evaluate the input image at block 10 (FIG. 1). External device 89 may store a dictionary, and network I/F 86 may be configured to communicate with external device 89 to allow processor 81 to reference the dictionary at block 11 (FIG. 1). External device 89 may store a set of probabilities of confusion between characters (e.g., probabilities of FIG. 2 or FIG. 3), and network I/F 86 may be configured to receive the set of probabilities from external device 89 at block 13 (FIG. 1). Network I/F 86 may be configured to transmit to memory of external device 89, the output texts that were selected at block 15 (FIG. 1), and/or an electronic document that comprises the output texts, and/or the image after the image is encoded with the output texts.

While several particular forms of the invention have been illustrated and described, it will also be apparent that various modifications may be made without departing from the scope of the invention. It is also contemplated that various combinations or subcombinations of the specific features and aspects of the disclosed embodiments may be combined with or substituted for one another in order to form varying modes of the invention. Accordingly, it is not intended that the invention be limited, except as by the appended claims.

1. A text recognition method performed by a computer system, the method comprising:
obtaining a plurality of output candidate texts for an input text, the input text defined by a plurality of N-grams, each output candidate text defined by a plurality of N-grams;
computing a text matching score for each one of the output candidate texts, the computing for each output candidate text comprising
using the N-grams of the input text, the N-grams of the output candidate text, and a set of probabilities of confusion between characters to determine an N-gram score for each one of a plurality of N-gram pairs, each N-gram pair comprising a respective one of the N-grams of the input text and a respective one of the N-grams of the output candidate text, and
using the N-gram score of one or more of the N-gram pairs to compute the text matching score of the output candidate text; and
selecting one of the output candidate texts to be an output text for the input text, the selecting performed according to the text matching score of the output text.

2. The text recognition method of claim 1, wherein the input text consists of a single word comprising a plurality of characters.

3. The text recognition method of claim 1, wherein the input text comprises a plurality of words separated by space characters, and at least one of the N-grams of input text contains the space characters.

4. The text recognition method of claim 1, further comprising associating the output text with an image from which the input text was derived.

5. The text recognition method of claim 1, further comprising associating the output text with a location of the input text within an image from which the input text was derived.

6. The text recognition method of claim 1, further comprising generating an electronic document that comprises the output text.

7. The text recognition method of claim 1, wherein for each one of the plurality of N-gram pairs, applying a rule to compute the N-gram score of the N-gram pair, the rule comprising setting the N-gram score to a probability-based value if the N-gram of the input text and the N-gram of the output candidate text of the N-gram pair differ in content by no more than one character position, the probability-based value is based on a probability of confusion between a differentiating character of the N-gram of the input text and a differentiating character of the N-gram of the output candidate text.

8. The text recognition method of claim 7, wherein a total character count is the same for each of the N-grams of the input text and the N-grams of the output candidate text, and the probability-based value is a value normalized according to the total character count.

9. The text recognition method of claim 7, wherein the probability-based value is no greater than a maximum value, and rule comprises setting the N-gram score to the maximum value if the N-gram of the input text and the N-gram of the output candidate text of the N-gram pair have all character positions that are the same in content.

10. The text recognition method of claim 1, wherein for each one of the output candidate texts, the text matching score is determined from a sum that is greatest among a plurality of sums, each sum is a sum of N-gram scores taken across a respective diagonal along one or more cells of a matrix, the cells are arranged along a first matrix dimension and a second matrix dimension, the first matrix dimension corresponds to the N-grams of the input text arranged in sequential order, the second matrix dimension corresponds to the N-grams of the candidate text arranged in sequential order, each cell contains the N-gram score of an N-gram pair defined by a matrix intersection of a respective N-gram of the first matrix dimension and a respective N-gram of the second matrix dimension.

11. The text recognition method of claim 10, wherein the sum that is greatest among the plurality of sums is referred to as a maximal sum, and the text matching score is determined by normalizing the maximal sum according to a total count of the N-grams of the input text or a total count of the N-grams of the output candidate text.

12. The text recognition method of claim 1, wherein the input text is referred to as a first input text, the output candidate texts are referred to as first output candidate texts, the plurality of N-gram pairs is referred to as a first plurality of N-gram pairs, the output text is referred to as a first output text, and the method further comprises:
evaluating an image to derive the first input text and a second input text from the image;
obtaining a plurality of second output candidate texts for the second input text, the second input text defined by a plurality of N-grams, each second output candidate text defined by a plurality of N-grams;
computing a text matching score for each one of the second output candidate texts, the computing for each second output candidate text comprising
using the N-grams of the second input text, the N-grams of the second output candidate text, and the set of probabilities of confusion between characters to determine an N-gram score for each one of a second plurality of N-gram pairs, each N-gram pair comprising a respective one of the N-grams of the second input text and a respective one of the N-grams of the second output candidate text, and
using the N-gram score of one or more of the second plurality of N-gram pairs to compute the text matching score of the second output candidate text;
selecting one of the second output candidate texts to be a second output text for the second input text, the selecting performed according to the text matching score of the second output text.

13. The text recognition method of claim 12, further comprising any one or a combination of associating the second output text with the image, associating the second output text with a location of the second input text within the image, and generating an electronic document that comprises the second output text.

14. A text recognition system comprising:
a processor; and
a memory in communication with the processor, the memory storing instructions, wherein the processor is configured to perform a text recognition process according to the stored instructions, the text recognition process comprising:
obtaining a plurality of output candidate texts for an input text, the input text defined by a plurality of N-grams, each output candidate text defined by a plurality of N-grams;
computing a text matching score for each one of the output candidate texts, the computing for each output candidate text comprising
using the N-grams of the input text, the N-grams of the output candidate text, and a set of probabilities of confusion between characters to determine an N-gram score for each one of a plurality of N-gram pairs, each N-gram pair comprising a respective one of the N-grams of the input text and a respective one of the N-grams of the output candidate text, and
using the N-gram score of one or more of the N-gram pairs to compute the text matching score of the output candidate text; and
selecting one of the output candidate texts to be an output text for the input text, the selecting performed according to the text matching score of the output text.

15. The text recognition system of claim 14, wherein the input text consists of a single word comprising a plurality of characters.

16. The text recognition system of claim 14, wherein the input text comprises a plurality of words separated by space characters, and at least one of the N-grams of input text contains the space characters.

17. The text recognition system of claim 14, wherein the text recognition process further comprises associating the output text with an image from the input text was derived.

18. The text recognition system claim 14, wherein the text recognition process further comprises associating the output text with a location of the input text within an image from the input text was derived.

19. The text recognition system of claim 14, wherein the text recognition process further comprises generating an electronic document that comprises the output text.

20. The text recognition system of claim 14, wherein for each one of the plurality of N-gram pairs, applying a rule to compute the N-gram score of the N-gram pair, the rule comprising setting the N-gram score to a probability-based value if the N-gram of the input text and the N-gram of the output candidate text of the N-gram pair differ in content by no more than one character position, the probability-based value is based on a probability of confusion between a differentiating character of the N-gram of the input text and a differentiating character of the N-gram of the output candidate text.

21-26. (canceled)
